(19) United States
(12) Patent Application Publication
(10) Pub. No.: US 2022/0199045 A1
(43) Pub. Date: Jun. 23, 2022

(54) DISPLAYING SYSTEMS AND METHODS

(71) Applicant: ZHONGSHAN XIAOWU LIGHTING TECHNOLOGY CO., LTD., Zhongshan, Guangdong (CN)

(72) Inventor: Qi YAO, Shenzhen (CN)

(73) Assignee: ZHONGSHAN XIAOWU LIGHTING TECHNOLOGY CO., LTD., Zhongshan, Guangdong (CN)

(21) Appl. No.: 17/594,621

(22) PCT Filed: Apr. 15, 2020
(86) PCT No.: PCT/CN2020/084900

§ 371 Date: Oct. 25, 2021

(30) Foreign Application Priority Data
Apr. 25, 2019 (CN) 2019 10339632.3
Feb. 27, 2020 (CN) 2020 10122980.8

(51) Int. Cl. G09G 3/34

(52) U.S. Cl. CPC G09G 3/3406; G09G 2320/0242; G09G 2320/0666

(57) ABSTRACT

The present disclosure relates to displaying systems and methods. A displaying method may include adjusting one or more parameters of a backlight source of a display screen, wherein the one or more parameters include: a spectral full width at half maximum (FWHM) of a working channel of the backlight source, a peak wavelength of a working channel of the backlight source, and a first count of working channels of the backlight source; obtaining a first spectral curve of a reference object that the display screen displays under a predetermined reference light after adjusting the one or more parameters of the backlight source of the display screen; obtaining a target spectral curve of the reference object under the predetermined reference light; and controlling the display screen to display the reference object based on the first spectral curve and the target spectral curve.

### CROSS-REFERENCE TO RELATED APPLICATIONS

This application claims priority of Chinese Application No. 201910339632.3, filed on Apr. 25, 2019, and Chinese Application No. 202010122980.8, filed on Feb. 27, 2020, the contents of which are incorporated herein in its entirety by reference.

### TECHNICAL FIELD

The present disclosure generally relates to displaying systems and methods, and more particularly, to systems and methods for displaying objects on a display screen to simulate natural display effects and for assessing displaying performances of the display screen.

### BACKGROUND

Existing display methods often display an object to simulate natural chromaticity of the object. However, with the existing methods, spectral power distributions (SPD, also refers to spectral curve) of the displayed object are not continuous and different from that of the same object displayed in natural scenes under a same reference light. Therefore, the display effects of the existing display methods deviate from the natural display effect and may cause potential damage to user's visual health. In addition, a user may absorb a large amount of radiation dose after using a display screen for a long time. It is important to assess displaying performances associated with human's health. Therefore, it is desirable to provide systems and methods for displaying and assessing a display screen.

### SUMMARY

An aspect of the present disclosure introduces a displaying system. The displaying system may include at least one storage medium including a set of instructions and at least one processor in communication with the storage medium. When executing the set of instructions, the at least one processor is directed to cause the system to perform operations including: adjusting one or more parameters of a backlight source of a display screen, wherein the one or more parameters include: a spectral full width at half maximum (FWHM) of a working channel of the backlight source, a peak wavelength of a working channel of the backlight source, and a first count of working channels of the backlight source; obtaining a first spectral curve of a reference object that the display screen displays under a predetermined reference light after adjusting the one or more parameters of the backlight source of the display screen; obtaining a target spectral curve of the reference object under the predetermined reference light; and controlling the display screen to display the reference object based on the first spectral curve and the target spectral curve.

In some embodiments, the adjusting the one or more parameters includes at least one of: increasing a spectral FWHM of a first working channel of the backlight source to a first value greater than a first width threshold; decreasing a spectral FWHM of a second working channel of the backlight source to a second value less than a second width threshold; or increasing the first count of working channels of the backlight source.

In some embodiments, the operations further include determining the continuity degree of the first spectral curve according to a spectral similarity algorithm, wherein a continuity degree of the first spectral curve exceeds a predetermined continuity threshold.

In some embodiments, the obtaining the first spectral curve includes: determining a second count of total channels of the backlight source; determining whether the second count exceeds 3; in response to a determination that the second count exceeds 3, obtaining a plurality of first candidate curves under the predetermined reference light that the display screen outputs; and selecting the first spectral curve from the plurality of first candidate curves according to a predetermined selecting algorithm.

In some embodiments, the obtaining the target spectral curve includes: obtaining a spectral reflection curve of the reference object; obtaining a spectral curve of the predetermined reference light; and determining the target spectral curve based on the spectral reflection curve of the reference object and the spectral curve of the predetermined reference light.

In some embodiments, the controlling the display screen to display the reference object includes: determining a similarity degree between the first spectral curve and the target spectral curve; determining whether the similarity degree is less than a similarity threshold; in response to a determination that the similarity degree is less than the similarity threshold, adjusting one or more parameters associated with the backlight source of the display screen.

In some embodiments, the operations further include in response to a determination that the similarity degree is not less than the similarity threshold, controlling the display screen to display the reference object based on the first spectral curve.

In some embodiments, the operations further include: determining an assessment index of the display screen, wherein the assessment index includes at least one of: a luminous efficiency of radiation (LER), a melanotic efficiency of radiation (M_{Z}ER), a melanotic/photopic ratio (M_{Z}/P), or a blue light hazard (BLH).

In some embodiments, the determining the assessment index includes: determining a chromaticity-performance relation, wherein the chromaticity-performance relation reflects a function between a chromaticity value of a pixel and an assessment index of the pixel; for a pixel in a plurality of frames displayed on the display screen, determining a chromaticity value of the pixel; and determining the assessment index based on the chromaticity values of the pixels in the plurality of frames and the chromaticity-performance relation.

Another aspect of the present disclosure introduces a displaying method. The displaying method may include adjusting one or more parameters of a backlight source of a display screen, wherein the one or more parameters include: a spectral full width at half maximum (FWHM) of a working channel of the backlight source, a peak wavelength of a working channel of the backlight source, and a first count of working channels of the backlight source; obtaining a first spectral curve of a reference object that the display screen displays under a predetermined reference light after adjusting the one or more parameters of the backlight source of the display screen; obtaining a target spectral curve of the reference object under the predetermined reference light; and controlling the display screen to display the reference object based on the first spectral curve and the target spectral curve.

Still another aspect of the present disclosure introduces a non-transitory computer readable medium. The non-transitory computer readable medium may include at least one set of instructions, wherein when executed by at least one processor of an electrical device, the at least one set of instructions directs the at least one processor to perform a displaying method. The displaying method may include: adjusting one or more parameters of a backlight source of a display screen, wherein the one or more parameters include: a spectral full width at half maximum (FWHM) of a working channel of the backlight source, a peak wavelength of a working channel of the backlight source, and a first count of working channels of the backlight source; obtaining a first spectral curve of a reference object that the display screen displays under a predetermined reference light after adjusting the one or more parameters of the backlight source of the display screen; obtaining a target spectral curve of the reference object under the predetermined reference light; and controlling the display screen to display the reference object based on the first spectral curve and the target spectral curve.

Still another aspect of the present disclosure introduces a system for assessing a display screen. The system may include at least one storage medium including a set of instructions for assessing the display screen; and at least one processor in communication with the storage medium. When executing the set of instructions, the at least one processor is directed to cause the system to perform operations including: determining a chromaticity-performance relation, wherein the chromaticity-performance relation reflects a function between a chromaticity value of a pixel and an assessment index of the pixel, and the assessment index includes at least one of: a luminous efficiency of radiation (LER), a melanotic efficiency of radiation (M_{Z}ER), a melanotic/photopic ratio (M_{Z}/P), or a blue light hazard (BLH); for each pixel in a plurality of frames displayed on the display screen, determining a chromaticity value of the pixel; and determining an assessment index of the display screen based on the chromaticity values of the pixels in the plurality of frames and the chromaticity-performance relation.

In some embodiments, the chromaticity values include CIE 1931 xy chromaticity values or gray intensities.

In some embodiments, the determining the chromaticity-performance relation includes: obtaining a plurality of spectral power distributions (SPD) at a plurality of gray intensities for each channel of a backlight source of the display screen; determining a gamma relation between a sum of spectral radiances and gray intensities based on the plurality of SPDs and the plurality of gray intensities for each channel; and determining the chromaticity-performance relation based on the gamma relation and a reference assessment index, wherein the chromaticity-performance reflects a function between gray intensities of pixels and the assessment index.

In some embodiments, the operations further include: determining a spectrum proportion of each channel based on the gamma relation and each pixel of the plurality of pixels; determining a pixel assessment index of each pixel based on the spectrum proportion of each channel and a SPD of each channel; and determining the assessment index of the display screen based on the pixel assessment index of each pixel.

In some embodiments, the determining the chromaticity-performance relation includes: obtaining a plurality of reference assessment indexes of a plurality of reference pixels of different chromaticity values that the display screen displays; for each reference pixel of the plurality of reference pixels, determining a chromaticity value; and determining the chromaticity-performance relation based on the plurality of reference assessment indexes and the plurality of chromaticity values of the plurality of reference pixels.

In some embodiments, the chromaticity-performance relation is in a form of a contour map, an explicit function, or a fitting function.

In some embodiments, the obtaining the plurality of reference assessment indexes of the plurality of reference pixels includes: for each reference pixel of the plurality of reference pixels, obtaining spectral information of the reference pixel; and determining a reference assessment index of the reference pixel based on the spectral information of the reference pixel.

In some embodiments, the spectral information of the reference pixel includes SPD information or spectral intensity information.

In some embodiments, the operations further include: obtaining the plurality of frames that the display screen displays according to a predetermined rule; for each frame of the plurality of frames, determining a frame assessment index based on the chromaticity value of each pixel in the frame and the chromaticity-performance relation; and determining the assessment index of the display screen based on the frame assessment index of each frame of the plurality of frames.

In some embodiments, for each frame of the plurality of frames, the determining the frame assessment index based on the chromaticity value of each pixel in the frame and the chromaticity-performance relation includes: for each frame of the plurality of frames, determining a pixel count of pixels in the frame; determining a reference pixel assessment index in the frame; and determining the frame assessment index of the frame based on the pixel count of pixels and the reference pixel assessment index in the frame.

In some embodiments, the determining the assessment index of the display screen based on the frame assessment index of each frame of the plurality of frames includes: determining a frame count of the plurality of frames; determining a reference frame assessment index of a reference frame selected from the plurality of frames; and determining the assessment index of the display screen based on the frame count and the reference frame assessment index.

Another aspect of the present disclosure introduces a method for assessing a display screen. The method may include determining a chromaticity-performance relation, wherein the chromaticity-performance relation reflects a function between a chromaticity value of a pixel and an assessment index of the pixel, and the assessment index includes at least one of: a luminous efficiency of radiation (LER), a melanotic efficiency of radiation (M_{Z}ER), a melanotic/photopic ratio (M_{Z}/P), or a blue light hazard (BLH); for each pixel in a plurality of frames displayed on the display screen, determining a chromaticity value of the pixel; and determining an assessment index of the display screen based on the chromaticity values of the pixels in the plurality of frames and the chromaticity-performance relation.

Still another aspect of the present disclosure introduces a non-transitory computer readable medium. The non-transitory computer readable medium may include at least one set of instructions for assessing a display screen, wherein when executed by at least one processor of an electrical device, the at least one set of instructions directs the at least one processor to perform a method. The method may include: determining a chromaticity-performance relation, wherein the chromaticity-performance relation reflects a function between a chromaticity value of a pixel and an assessment index of the pixel, and the assessment index includes at least one of: a luminous efficiency of radiation (LER), a melanotic efficiency of radiation (M_{Z}ER), a melanotic/photopic ratio (M_{Z}/P), or a blue light hazard (BLH); for each pixel in a plurality of frames displayed on the display screen, determining a chromaticity value of the pixel; and determining an assessment index of the display screen based on the chromaticity values of the pixels in the plurality of frames and the chromaticity-performance relation.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary displaying system according to some embodiments of the present disclosure;

FIG. 2 is a schematic diagram illustrating exemplary hardware and/or software components of a computing device according to some embodiments of the present disclosure;

FIG. 3 is a block diagram illustrating an exemplary processing engine according to some embodiments of the present disclosure;

FIG. 4 is a block diagram illustrating an exemplary assessing module according to some embodiments of the present disclosure;

FIG. 5 is a flowchart illustrating an exemplary process for displaying on the display screen according to some embodiments of the present disclosure;

FIG. 6 is a schematic diagram illustrating an exemplary spectral curve of a backlight source including three channels according to some embodiments of the present disclosure;

FIG. 7 is a schematic diagram illustrating an exemplary spectral curve of a backlight source including four channels according to some embodiments of the present disclosure;

FIG. 8 is a schematic diagram illustrating an exemplary spectral curve of a backlight source including at least five channels according to some embodiments of the present disclosure;

FIG. 9 is a schematic diagram illustrating an exemplary spectral curve of a backlight source including at least five channels according to some embodiments of the present disclosure;

FIG. 10 is a schematic diagram illustrating an exemplary first spectral curve of a chromaticity value that a display screen including three channels displays under CIE light source according to some embodiments of the present disclosure;

FIG. 11 is a flowchart illustrating an exemplary process for obtaining a first spectral curve of a reference object according to some embodiments of the present disclosure;

FIG. 12 is a flowchart illustrating an exemplary process for determining a target spectral curve of a reference object under a predetermined reference light according to some embodiments of the present disclosure;

FIG. 13 is a flowchart illustrating an exemplary process for controlling a display screen to display a reference object according to some embodiments of the present disclosure;

FIG. 14 is a flowchart illustrating an exemplary process for assessing a display screen according to some embodiments of the present disclosure;

FIG. 15 is a flowchart illustrating an exemplary process for determining a chromaticity-performance relation according to some embodiments of the present disclosure;

FIG. 16 are schematic diagrams illustrating exemplary spectral radiances of red, green, and blue channels (left column) and a sum of spectral radiances as functions of gray intensity (right column) according to some embodiments of the present disclosure;

FIG. 17 is a flowchart illustrating an exemplary process for determining an assessment index of a display screen according to some embodiments of the present disclosure;

FIG. 18 is a flowchart illustrating an exemplary process for determining a chromaticity-performance relation according to some embodiments of the present disclosure;

FIG. 19 are schematic diagrams illustrating exemplary chromaticity-performance relations according to some embodiments of the present disclosure;

FIG. 20 is a flowchart illustrating an exemplary process for determining an assessment index of a display screen according to some embodiments of the present disclosure;

FIG. 21 is a flowchart illustrating an exemplary process for determining a frame assessment index of a frame according to some embodiments of the present disclosure; and

FIG. 22 is a flowchart illustrating an exemplary process for determining an assessment index of a display screen according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to displaying systems and methods. To this end, the displaying systems and methods may adjust a spectral full width at half maximum (FWHM) of a working channel of a backlight source of a display screen, a peak wavelength of a working channel of the backlight source, or a first count of working channels of the backlight source to improve a color gamut and/or a spectral continuity that the display screen displays. The displaying systems and methods may determine a similarity of a displayed spectrum of a reference object on the display screen with a natural displayed spectrum under a same reference light. By comparing the similarity with a similarity threshold, the systems and methods may control the display screen to display the reference object, so that the display effect may be close to the natural display effect.

Another aspect of the present disclosure relates to systems and methods for assessing a display screen. To this end, the systems and methods may determine a chromaticity-performance relation that reflects a function between chromaticity values of pixels and assessment indexes thereof. The assessment indexes may include a luminous efficiency of radiation (LER), a melanotic efficiency of radiation (M_{Z}ER), a melanotic/photopic ratio (M_{Z}/P), or a blue light hazard (BLH). The systems and methods may determine a chromaticity value of a pixel in frames that displayed on the display screen and determine the corresponding assessment indexes of the pixel. The systems and methods may determine an assessment index of the display screen that associated with human health based on the assessment indexes of pixels in frames that displayed on the display screen. In this way, the systems and methods may assess the display screen according to chromaticity values rather than spectra, which may significantly decrease computational load precisely assess display performances or healthy performance of the display screen.

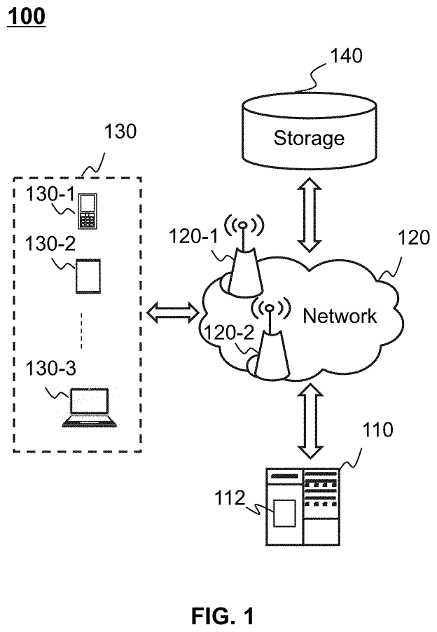

FIG. 1 is a schematic diagram of an exemplary displaying system 100 according to some embodiments of the present disclosure. The displaying system 100 may include a server 110, a network 120, a display screen 130, and a storage 140. The server 110 may include a processing engine 112.

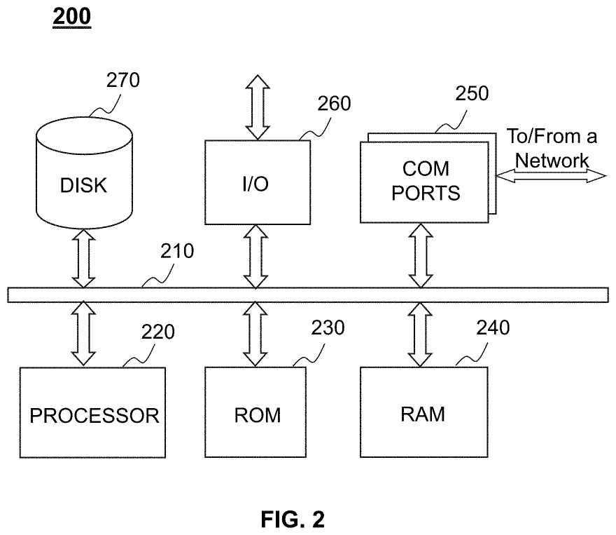

The server 110 may be configured to process information and/or data relating to displaying and assessment of the display screen 130. For example, the server 110 may adjust one or more parameters of a backlight source of the display screen 130. As another example, the server 110 may control the display screen 130 to display a reference object after adjusting the one or more parameters of the backlight source of the display screen 130. As still another example, the server 110 may determine a chromaticity-performance relation. The server 110 may further determine an assessment index of the display screen based on the chromaticity-performance relation. In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the display screen 130, and/or the storage 140 via the network 120. As another example, the server 110 may connect the display screen 130, and/or the storage 140 to access stored information and/or data. In some embodiments, the server 110 may be implemented on a cloud platform. Merely by way of example, the cloud platform may be a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to displaying and assessment of the display screen 130. For example, the processing engine 112 may adjust one or more parameters of a backlight source of the display screen 130. As another example, the processing engine 112 may control the display screen 130 to display a reference object after adjusting the one or more parameters of the backlight source of the display screen 130. As still another example, the processing engine 112 may determine a chromaticity-performance relation. The processing engine 112 may further determine an assessment index of the display screen based on the chromaticity-performance relation. In some embodiments, the processing engine 112 may include one or more processing engines (e.g., single-core processing engine(s) or multi-core processor(s)). Merely by way of example, the processing engine 112 may be one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the displaying system 100 (e.g., the server 110, the display screen 130, and the storage 140) may transmit information and/or data to another component (s) in the displaying system 100 via the network 120. For example, the server 110 may send control instructions of the display screen 130 via the network 120. As another example, the server 110 may obtain parameters of the backlight source from the display screen 130 via the network 120. As still another example, the server 110 may obtain pixels in a plurality of frames displayed on the display screen 130 from the display screen 130 via the network 120. In some embodiments, the network 120 may be any type of wired or wireless network, or combination thereof. Merely by way of example, the network 130 may be a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the displaying system 100 may be connected to the network 120 to exchange data and/or information between them.

The display screen 130 may be a display screen of any electronic device. In some embodiments, the electronic device may be a mobile device 130-1, a tablet computer 130-2, a laptop computer 130-3, or the like, or any combination thereof. In some embodiments, the mobile device 130-1 may be a wearable device, a smart mobile device, a virtual reality device, an augmented reality device, or the like, or any combination thereof. In some embodiments, the wearable device may be a smart bracelet, a smart footgear, a smart glass, a smart helmet, a smart watch, a smart clothing, a smart backpack, a smart accessory, or the like, or any combination thereof. In some embodiments, the smart mobile device may be a smartphone, a personal digital assistance (PDA), a gaming device, a navigation device, a point of sale (POS) device, or the like, or any combination thereof. In some embodiments, the virtual reality device and/or the augmented reality device may be a virtual reality helmet, a virtual reality glass, a virtual reality patch, an augmented reality helmet, an augmented reality glass, an augmented reality patch, or the like, or any combination thereof. For example, the virtual reality device and/or the augmented reality device may be a Google Glass™, a RiftCon™, a Fragments™, a Gear VR™, etc.

The storage 140 may store data and/or instructions. For example, the storage 140 may store parameters of the backlight source of the display screen 130. As another example, the storage 140 may store a predetermined chromaticity-performance relation. As still another example, the storage 140 may store data and/or instructions that the server 110 may execute or use to perform exemplary methods described in the present disclosure. In some embodiments, the storage 140 may be a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 140 may be implemented on a cloud platform. Merely by way of example, the cloud platform may be a private cloud, a public cloud, a hybrid cloud, a community cloud, a distributed cloud, an inter-cloud, a multi-cloud, or the like, or any combination thereof.

In some embodiments, the storage 140 may include at least one network port to communicate with other devices in the displaying system 100. For example, the storage 140 may be connected to the network 120 to communicate with one or more components of the displaying system 100 (e.g., the server 110, the display screen 130) via the at least one network port. One or more components in the displaying system 100 may access the data or instructions stored in the storage 140 via the network 120. In some embodiments, the storage 140 may be directly connected to or communicate with one or more components in the displaying system 100 (e.g., the server 110, the display screen 130). In some embodiments, the storage 140 may be part of the server 110.

In some embodiments, one or more components of the displaying system 100 (e.g., the server 110, the display screen 130, and the storage 140) may communicate with each other in form of electronic and/or electromagnetic signals, through wired and/or wireless communication. In some embodiments, the displaying system 100 may further include at least one data exchange port. The at least one exchange port may be configured to receive information and/or send information relating to the displaying and the assessment of the display screen 130 (e.g., in form of electronic signals and/or electromagnetic signals) between any electronic devices in the displaying system 100. In some embodiments, the at least one data exchange port may be one or more of an antenna, a network interface, a network port, or the like, or any combination thereof. For example, the at least one data exchange port may be a network port connected to the server 110 to send information thereto and/or receive information transmitted therefrom.

FIG. 2 is a schematic diagram illustrating exemplary hardware and software components of a computing device 200 on which the server 110, and/or the display screen 130 may be implemented according to some embodiments of the present disclosure. For example, the processing engine 112 may be implemented on the computing device 200 and configured to perform functions of the processing engine 112 disclosed in this disclosure.

The computing device 200 may be used to implement a displaying system 100 for the present disclosure. The computing device 200 may be used to implement any component of the displaying system 100 that performs one or more functions disclosed in the present disclosure. For example, the processing engine 112 may be implemented on the computing device 200, via its hardware, software program, firmware, or a combination thereof. Although only one such computer is shown, for convenience, the computer functions relating to the online to offline service as described herein may be implemented in a distributed fashion on a number of similar platforms, to distribute the processing load.

The computing device 200, for example, may include COM ports 250 connected to and from a network connected thereto to facilitate data communications. The COM port 250 may be any network port or data exchange port to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. The processing circuits may also generate electronic signals including the conclusion or the result (e.g., the control instructions) and a triggering code. In some embodiments, the trigger code may be in a format recognizable by an operation system (or an application installed therein) of an electronic device (e.g., the display screen 130) in the displaying system 100. For example, the trigger code may be an instruction, a code, a mark, a symbol, or the like, or any combination thereof, that can activate certain functions and/or operations of a mobile phone or let the mobile phone execute a predetermined program(s). In some embodiments, the trigger code may be configured to rend the operation system (or the application) of the electronic device to generate a presentation of the conclusion or the result (e.g., a prediction result) on an interface of the electronic device. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The exemplary computing device may also include operating systems stored in the ROM 230, RAM 240, and/or other type of non-transitory storage medium to be executed by the processor 220. The program instructions may be compatible with the operation systems for providing the online to offline service. The computing device 200 also includes an I/O component 260, supporting input/output between the computer and other components. The computing device 200 may also receive programming and data via network communications.

Merely for illustration, only one processor is illustrated in FIG. 2. Multiple processors are also contemplated; thus, operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

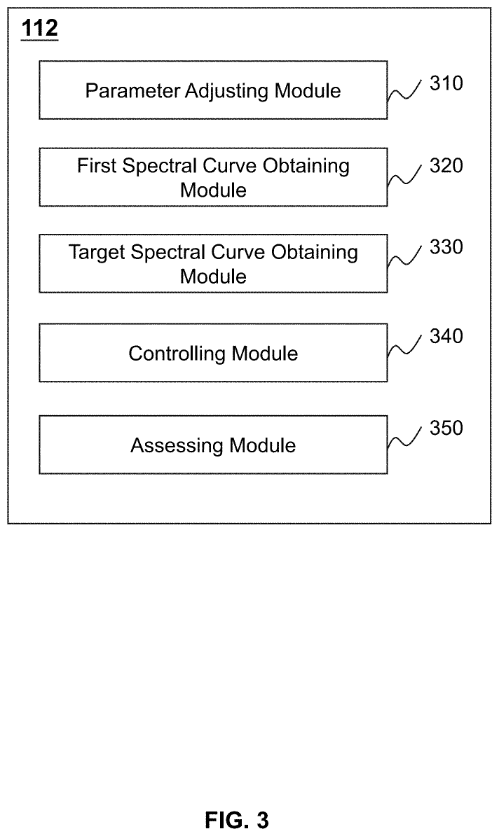

FIG. 3 is a block diagram illustrating an exemplary processing engine 112 according to some embodiments of the present disclosure. As illustrated in FIG. 3, the processing engine 112 may include a parameter adjusting module 310, a first spectral curve obtaining module 320, a target spectral curve obtaining module 330, a controlling module 340, and an assessing module 350.

The parameter adjusting module 310 may be configured to adjust one or more parameters of a backlight source of the display screen 130.

The first spectral curve obtaining module 320 may be configured to obtain a first spectral curve of a reference object that the display screen displays under a predetermined reference light after adjusting the one or more parameters of the backlight source of the display screen. For example, the first spectral curve obtaining module 320 may determine a second count of total channels of a backlight source of the display screen 130. The first spectral curve obtaining module 320 may determine whether the second count exceeds 3. If the second count exceeds 3, the first spectral curve obtaining module 320 may obtain a plurality of first candidate curves under a predetermined reference light that the display screen 130 outputs and select the first spectral curve from the plurality of first candidate curves according to a predetermined selecting algorithm.

The target spectral curve obtaining module 330 may be configured to obtain a target spectral curve of the reference object under the predetermined reference light. For example, the target spectral curve obtaining module 330 may obtain a spectral reflection curve of the reference object and a spectral curve of the predetermined reference light. The target spectral curve obtaining module 330 may determine the target spectral curve based on the spectral reflection curve of the reference object and the spectral curve of the predetermined reference light.

The controlling module 340 may be configured to control the display screen to display the reference object based on the first spectral curve and the target spectral curve. In some embodiments, the controlling module 340 may adjust one or more parameters associated with the backlight source of the display screen. In some embodiments, the controlling module 340 may instruct the display screen 130 to display the reference object directly.

The assessing module 350 may be configured to controlling module 340 may assess display performances or healthy performances of the display screen. In some embodiments, the assessing module 350 may determine an assessment index of the display screen 130.

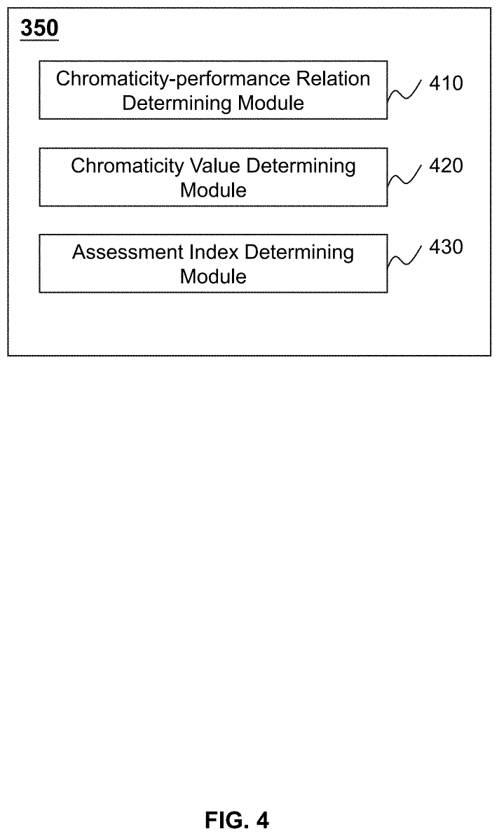

FIG. 4 is a block diagram illustrating an exemplary assessing module 350 according to some embodiments of the present disclosure. As illustrated in FIG. 4, the assessing module 350 may include a chromaticity-performance relation determining module 410, a chromaticity value determining module 420, and an assessment index determining module 430.

The chromaticity-performance relation determining module 410 may be configured to determine a chromaticity-performance relation. In some embodiments, the chromaticity-performance relation determining module 410 may obtain a plurality of spectral power distributions (SPD) at a plurality of gray intensities for each channel of a backlight source of the display screen 130, and determine a gamma relation between a sum of spectral radiances and gray intensities based on the plurality of SPDs and the plurality of gray intensities for each channel. In some embodiments, the chromaticity-performance relation determining module 410 may obtain a plurality of reference assessment indexes of a plurality of reference pixels of different chromaticity values that the display screen 130 displays and a chromaticity value of each reference pixels. The chromaticity-performance relation determining module 410 may determine the chromaticity-performance relation based on the plurality of reference assessment indexes and the plurality of chromaticity values of the plurality of reference pixels.

The chromaticity value determining module 420 may be configured to determine a chromaticity value of each pixel in a plurality of frames displayed on the display screen 130.

The assessment index determining module 430 may be configured to determine an assessment index of the display screen 130, a frame assessment index of a frame in the plurality of frames, or a pixel assessment index of a pixel in the plurality of frames.

The modules in the assessing module 350 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the first spectral curve obtaining module 320 and the target spectral curve obtaining module 330 may be combined as a module to obtain both the first spectral curve and the target spectral curve. As another example, the assessing module 350 may include a storage module (not shown) used to store data and/or information relating to the displaying on the display screen 130.

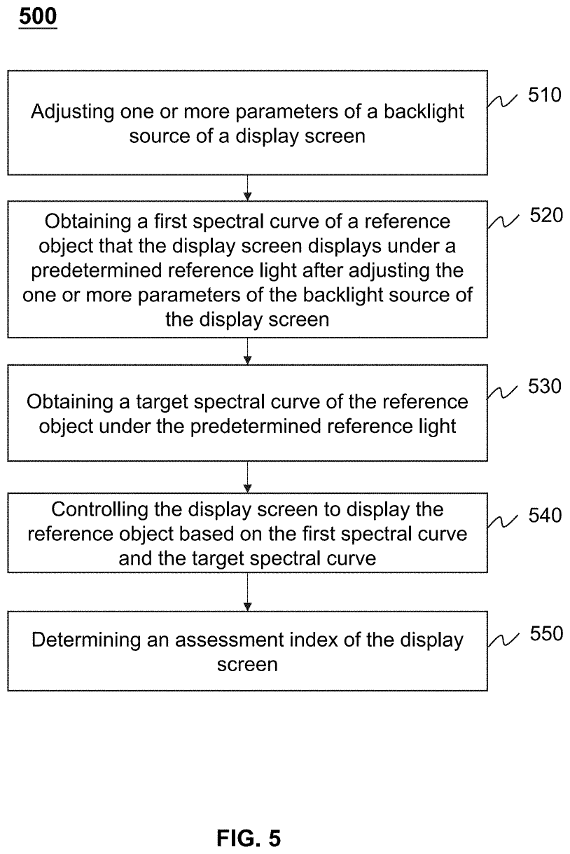

FIG. 5 is a flowchart illustrating an exemplary process 500 for displaying on the display screen 130 according to some embodiments of the present disclosure. The process 500 may be executed by the displaying system 100. For example, the process 500 may be implemented as a set of instructions (e.g., an application) stored in the storage ROM 230 or RAM 240. The processor 220 may execute the set of instructions, and when executing the instructions, it may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5 and described below is not intended to be limiting.

In 510, the processing engine 112 (e.g., the processor 220, the parameter adjusting module 310) may adjust one or more parameters of a backlight source of the display screen 130.

In some embodiments, the one or more parameters of the backlight source may include a spectral full width at half maximum (FWHM) of a working channel of the backlight source, a peak wavelength of a working channel of the backlight source, a first count of working channels of the backlight source, or the like, or any combination thereof. In some embodiments, adjusting the one or more parameters of the backlight source may change the original displayed color gamut and/or a spectral continuity that the display screen displays. In some embodiments, the processing engine 112 may obtain original parameters of the backlight source and adjust the original parameters to a new value. In some embodiments, the processing engine 112 may implement one or more methods (e.g., an enhancement method, adding a filter) on the original backlight source to adjust parameters of the backlight source.

In some embodiments, a count of channels of the backlight source may be equal to or greater than three. For example, the backlight source may be a RGB backlight source that includes three channels of R channel, G channel, and B channel. As another example, the backlight source may be a RGBW backlight source that includes four channels of R channel, G channel, B channel, and W channel. As still another example, the backlight source may include five channels. In some embodiments, one or more channels of the backlight source may be turned off to remain working channels. For example, in a RGBW backlight source, B channel may be turned off, and the working channels may include the remaining R channel, G channel, and W channel. As another example, in the RGBW backlight source, the working channels may include R channel, G channel, B channel, and W channel. In some embodiments, the spectral FWHM of a channel may be a difference between two wavelengths whose corresponding spectral intensity is equal to half of the maximum spectral intensity in a spectral curve of the channel. In some embodiments, the peak wavelength of a channel may be a wavelength value whose corresponding spectral intensity is the maximum in a spectral curve of the channel.

In some embodiments, the processing engine 112 may obtain an original spectral FWHM of a working channel of the backlight source. The processing engine 112 may increase the original spectral FWHM of the working channel to a first value greater than a first width threshold. In some embodiments, the first width threshold may be a predetermined value stored in a storage device of the displaying system (e.g., the storage 140, the ROM 230, the RAM 240, etc.), or determined by the displaying system or an operator thereof according to different application scenarios. For example, the first width threshold may be 30 nm, 50 nm, 100 nm, etc.

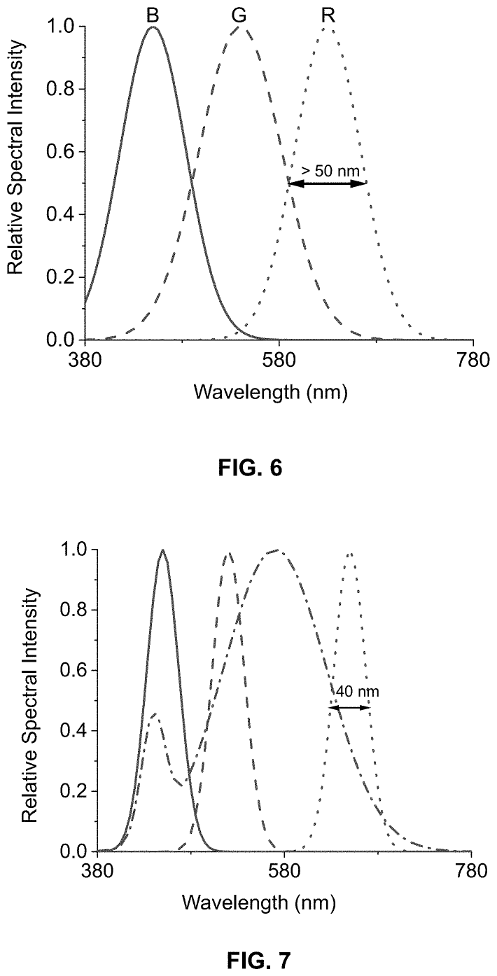

For example, in a RGB backlight source that includes three working channels. The processing engine 112 may increase the original spectral FWHM of each working channel (e.g., the R channel, G channel, and B channel) to a value greater than 50 nm. FIG. 6 is a schematic diagram illustrating an exemplary spectral curve of a backlight source including three channels according to some embodiments of the present disclosure. As shown in FIG. 6, the original spectral FWHM of the R channel, G channel, and/or B channel may be increased to a value greater than 50 nm, respectively. As another example, the processing engine 112 may increase the original spectral FWHM of each working channel (e.g., the R channel, G channel, and B channel) to a value greater than 100 nm.

In some embodiments, the processing engine 112 may increase a first original spectral FWHM of a first working channel to a first value greater than a first width threshold and/or decrease a second spectral FWHM of a second working channel of the backlight source to a second value less than a second width threshold. In some embodiments, the first width threshold and/or the second width threshold may be predetermined values stored in a storage device of the displaying system (e.g., the storage 140, the ROM 230, the RAM 240, etc.), or determined by the displaying system or an operator thereof according to different application scenarios. For example, the first width threshold and/or the second width threshold may 30 nm, 50 nm, 100 nm, etc. In some embodiments, the first width threshold may be the same with or different from the second width threshold.

For example, in a RGBW backlight source that includes four working channels. The processing engine 112 may designate spectral FWHMs of the R channel, G channel, and B channel to a value less than 50 nm, respectively, and a spectral FWHM of the W channel to a value greater than 100 nm. FIG. 7 is a schematic diagram illustrating an exemplary spectral curve of a backlight source including four channels according to some embodiments of the present disclosure. As shown in FIG. 7, the original spectral FWHM of the R channel, G channel, and B channel may be decreased to a 40 nm (less than 50 nm), respectively. The original spectral FWHM of the W channel may be increased to a value greater than 100 nm.

In some embodiments, in the RGBW backlight source, the processing engine 112 may further adjust peak wavelengths of working channels of the backlight source. For example, the processing engine 112 may adjust a peak wavelength of the W channel to make a difference between the peak wavelengths of the W channel and the R channel (and/or the G channel, the B channel) is greater than a difference threshold. In some embodiments, the difference threshold may be predetermined values stored in a storage device of the displaying system (e.g., the storage 140, the ROM 230, the RAM 240, etc.), or determined by the displaying system or an operator thereof according to different application scenarios.

In some embodiments, in a RGB backlight source, the processing engine 112 may designate spectral FWHMs of m channels as a value greater than a third width threshold and spectral FWHMs of n channels as a value greater than a fourth width threshold, wherein m and n are integers greater than 0. In some embodiments, the third width threshold and/or the fourth width threshold may be predetermined values stored in a storage device of the displaying system (e.g., the storage 140, the ROM 230, the RAM 240, etc.), or determined by the displaying system or an operator thereof according to different application scenarios. In some embodiments, the third width threshold and the fourth width threshold may be different from each other. For example, the processing engine 112 designate spectral FWHMs of each of the R channel, G channel, and B channel as a value greater than 50 nm, and a spectral FWHM of the W channel as a value greater than 100 nm.

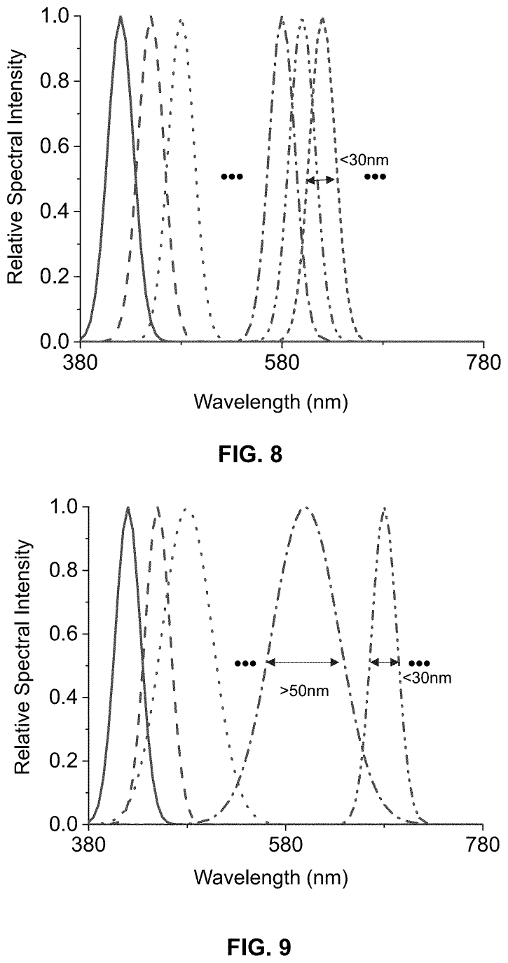

In some embodiments, for a backlight source including at least five working channels, the processing engine 112 may designate spectral FWHMs of one or more of the at least five working channels as a value less than a fifth width threshold. In some embodiments, the fifth width threshold may be predetermined values stored in a storage device of the displaying system (e.g., the storage 140, the ROM 230, the RAM 240, etc.), or determined by the displaying system or an operator thereof according to different application scenarios. FIG. 8 is a schematic diagram illustrating an exemplary spectral curve of a backlight source including at least five channels according to some embodiments of the present disclosure. As shown in FIG. 8, the processing engine 112 may designate a spectral FWHM of each channel of the at least five working channels to a value less than 30 nm.

FIG. 9 is a schematic diagram illustrating an exemplary spectral curve of a backlight source including at least five channels according to some embodiments of the present disclosure. As shown in FIG. 9, the processing engine 112 may designate spectral FWHMs of p working channels of the at least five working channels as a value less than a sixth width threshold, spectral FWHMs of q working channels of the at least five working channels as a value less than a seventh width threshold and greater than an eighth width threshold, and spectral FWHMs of r working channels of the at least five working channels as a value greater than an eighth width threshold, wherein p, q, and r are integers greater than 0.

In some embodiments, the processing engine 112 may increase the count of working channels of the backlight source. For example, if the count of working channels is less than a total count of channels of the backlight source, the processing engine 112 may select one or more off-working channels and change the off-working channels into working channels.

In some embodiments, adjusting the one or more parameters of the backlight source may improve the color gamut and/or the spectral continuity of the display screen 130. The display effect of the display screen 130 may be close to the natural display effect.

In 520, the processing engine 112 (e.g., the processor 220, the first spectral curve obtaining module 320) may obtain a first spectral curve of a reference object that the display screen displays under a predetermined reference light after adjusting the one or more parameters of the backlight source of the display screen.

In some embodiments, the predetermined reference light may be obtained from a predetermined reference source. For example, the predetermined reference source may include CIE standard lighting sources A, B, C, D, sunlight of different color temperatures, or the like, or any combination thereof. In some embodiments, the reference object may be used to evaluate the display effect of the display screen 130 after adjusting the one or more parameters of the backlight source. The processing engine 112 may compare the display effect of the display screen 130 and the natural display effect when displaying the reference object under the same predetermined reference light. In some embodiments, the reference object may be any object that exists in nature. For example, the reference object may include a fruit, a human, an animal, or the like, or any combination thereof. In some embodiments, the reference object may be represented as a chromaticity value. For example, the reference object may be represented as a CIE xy chromaticity value.

In some embodiments, when the display screen 130 outputs the predetermined reference light, the processing engine 112 may obtain the first spectral curve of the reference object from a spectral photometer. For example, when the display screen 130 outputs 5000K white light, the processing engine 112 may obtain the first spectral curve of an apple under the 5000K white light.

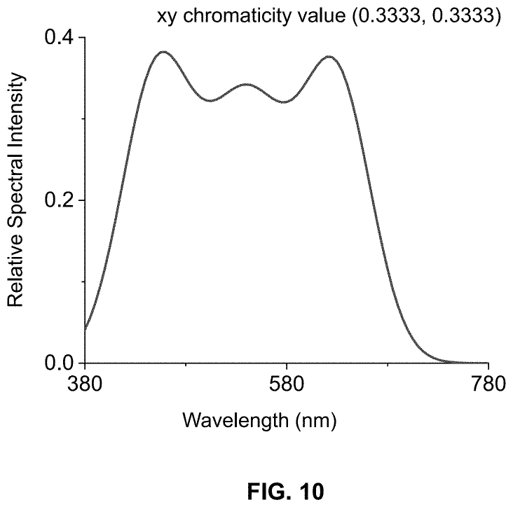

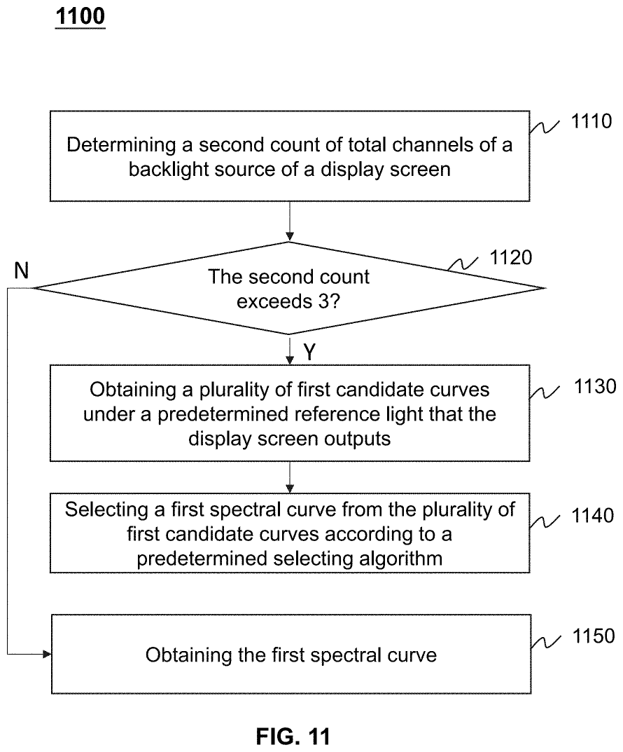

In some embodiments, the first spectral curve may reflect a relation between a spectral intensity (and a relative spectral intensity) and a chromaticity value that the display screen 130 displays. In some embodiments, each reference object or each chromaticity value may correspond to one first spectral curve. FIG. 10 is a schematic diagram illustrating an exemplary first spectral curve of a chromaticity value that a display screen including three channels displays under CIE light source according to some embodiments of the present disclosure. As shown in FIG. 10, the first spectral curve of the xy chromaticity value (0.3333, 0.3333) is continuous. In some embodiments, an exemplary process for obtaining the first spectral curve may be found elsewhere (e.g., FIG. 11 and the descriptions thereof) in the present disclosure.

In some embodiments, the processing engine 112 may determine a continuity degree of the first spectral curve. For example, the processing engine 112 may determine the continuity degree according to a spectral similarity algorithm. In some embodiments, the continuity degree of the first spectral curve may exceed a predetermined continuity threshold after adjusting the one or more parameters of the backlight source. In some embodiments, the spectral similarity algorithm may be a process or an algorithm for determining the continuity degree of the first spectral curve. In some embodiments, the predetermined continuity threshold may be a predetermined value stored in a storage device of the displaying system (e.g., the storage 140, the ROM 230, the RAM 240, etc.), or determined by the displaying system or an operator thereof according to different application scenarios.

In 530, the processing engine 112 (e.g., the processor 220, the target spectral curve obtaining module 330) may obtain a target spectral curve of the reference object under the predetermined reference light.

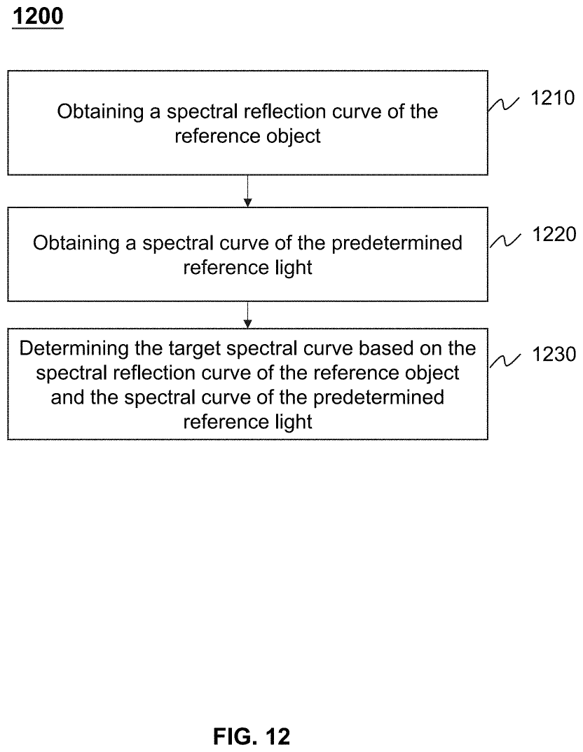

In some embodiments, the target spectral curve of the reference object may reflect a natural display effect of the reference object or the corresponding chromaticity value under the predetermined reference light. For example, the target spectral curve may be a spectral curve of an apple under the 5000K white light in the nature scene. In some embodiments, the processing engine 112 may obtain the target spectral curve of the reference object based on a spectral reflection curve of the reference object and a spectral curve of the predetermined reference light. The spectral reflection curve of the reference object and/or the spectral curve of the predetermined reference light may be predetermined and stored in a storage device of the displaying system (e.g., the storage 140, the ROM 230, the RAM 240, etc.). For example, the processing engine 112 may access the storage device to obtain the spectral reflection curve of the reference object and/or the spectral curve of the predetermined reference light. The processing engine 112 may multiply the spectral reflection curve of the reference object by the spectral curve of the predetermined reference light to determine the target spectral curve of the reference object under the predetermined reference light. In some embodiments, an exemplary process for obtaining the target spectral curve may be found elsewhere (e.g., FIG. 12 and the descriptions thereof) in the present disclosure.

In 540, the processing engine 112 (e.g., the processor 220, the controlling module 340) may control the display screen to display the reference object based on the first spectral curve and the target spectral curve.

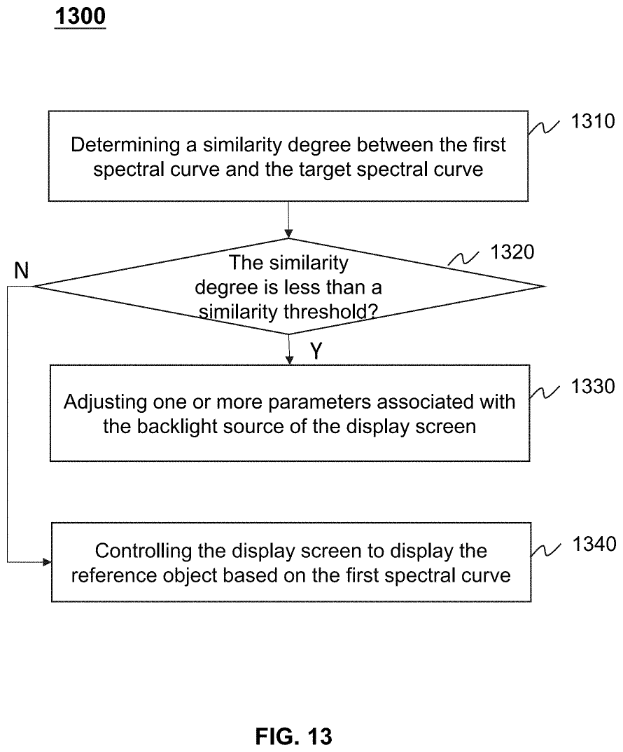

In some embodiments, the processing engine 112 may determine whether the display screen 130 displays the reference object close to natural display effect by comparing the first spectral curve and the target spectral curve. For example, the processing engine 112 may determine a similarity between the first spectral curve and the target spectral curve. If the similarity is greater than a similarity threshold, the processing engine 112 may determine that the display effect that the display screen 130 displays the reference object close to the natural display effect of the reference object. The processing engine 112 may instruct the display screen 130 to display the reference object directly after adjusting the one or more parameters of the backlight source. Otherwise, the processing engine 112 may determine that the display effect on the display screen 130 is not close to the natural display effect of the reference object, and may further adjust parameters associated with the backlight source. In some embodiments, the processing engine 112 may turn on one or more off-working channels to increase the current count of working channels of the backlight source. For example, in a backlight source having five channels, the current count of working channels is 3. The processing engine 112 may turn on one off-working channel of the backlight source. In some embodiments, the processing engine 112 may turn off one or more working channels to decrease to the current count of working channels of the backlight source. For example, in a backlight source having four channels of R channel, G channel, B channel, and W channel, the current count of working channels is 4. The processing engine 112 may turn off one working channel (such as B channel) of the backlight source. In some embodiments, the processing engine 112 may add a filter to the backlight source to adjust parameters of backlight source to make the display effect on the display screen 130 close to the natural display effect. In some embodiments, every adjusting the parameters associated with the backlight source, the processing engine 112 may obtain a second spectral curve of the reference object that the display screen 130 displays under the predetermined reference light, and determine a similarity between the second spectral curve and the target spectral curve until the similarity is greater than the similarity threshold. In some embodiments, an exemplary process for controlling the display screen to display the reference object may be found elsewhere (e.g., FIG. 13 and the descriptions thereof) in the present disclosure.

In 550, the processing engine 112 (e.g., the processor 220, the assessing module 350) may determining an assessment index of the display screen 130.

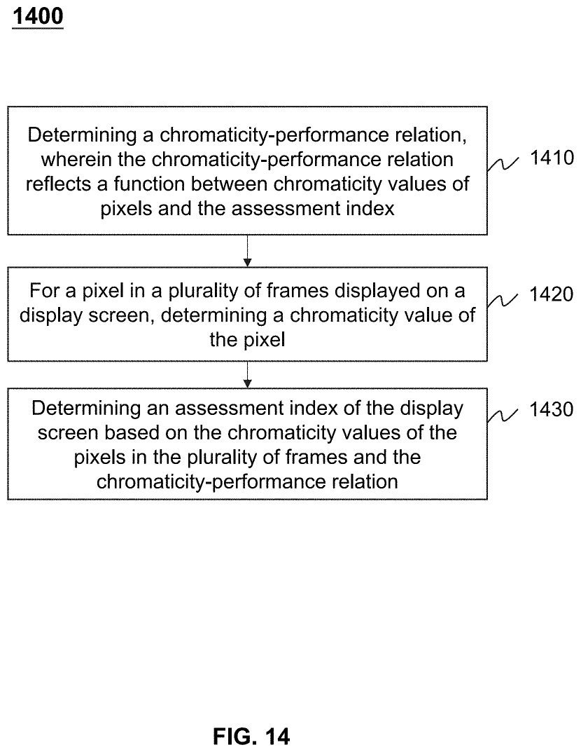

In some embodiments, the assessment index may be used to assess display performances or healthy performances that the display screen 130 causes for human. In some embodiments, the assessment index may include a luminous efficiency of radiation (LER), a melanotic efficiency of radiation (M_{Z}ER), a melanotic/photopic ratio (M_{Z}/P), a blue light hazard (BLH), an illumination or brightness, an equivalent melatonin illumination or brightness, a circadian light (CL_{A}), or the like, or any combination thereof. In some embodiments, the processing engine 112 may determine an assessment index of a pixel displayed on the display screen 130, and further determine an assessment index of a frame by determining a sum of assessment indexes of pixels in the frame. The processing engine 112 may further determine the assessment index of the display screen 130 by determining a sum of frames displayed on the display screen 130. In some embodiments, an exemplary process for assessing the display screen 130 may be found elsewhere (e.g., FIG. 14 and the descriptions thereof) in the present disclosure.

In some embodiments, the processing engine 112 may select a plurality of different reference objects or different chromaticity values, and determine a corresponding first spectral curve and a target spectral curve of each reference object or each chromaticity value, respectively. The processing engine 112 may assign a weight for each reference object or each chromaticity value, and control the display screen to display something based on the plurality of first spectral curves and target spectral curves. In some embodiments, the plurality of reference objects may be obtained from a database, such as a POINTER database.

It should be noted that the above description is merely provided for the purposes of illustration, and not intended to limit the scope of the present disclosure. For persons having ordinary skills in the art, multiple variations and modifications may be made under the teachings of the present disclosure. For example, operation 520 and operation 530 may be integrated into a single step for obtaining both the first spectral curve and the target spectral curve. As another example, operation 530 may be implemented before operation 510. However, those variations and modifications do not depart from the scope of the present disclosure.

FIG. 11 is a flowchart illustrating an exemplary process 1100 for obtaining a first spectral curve of a reference object according to some embodiments of the present disclosure. The process 1100 may be executed by the displaying system 100. For example, the process 1100 may be implemented as a set of instructions (e.g., an application) stored in the storage ROM 230 or RAM 240. The processor 220 may execute the set of instructions, and when executing the instructions, it may be configured to perform the process 1100. The operations of the illustrated process presented below are intended to be illustrative. In some embodiments, the process 1100 may be accomplished with one or more additional operations not described and/or without one or more of the operations discussed. Additionally, the order in which the operations of the process as illustrated in FIG. 11 and described below is not intended to be limiting.

In 1110, the processing engine 112 (e.g., the processor 220, the first spectral curve obtaining module 320) may determine a second count of total channels of a backlight source of the display screen 130.

In 1120, the processing engine 112 (e.g., the processor 220, the first spectral curve obtaining module 320) may determine whether the second count exceeds 3.

In 1130, in response to a determination that the second count exceeds 3, the processing engine 112 (e.g., the processor 220, the first spectral curve obtaining module 320) may obtain a plurality of first candidate curves under a predetermined reference light that the display screen 130 outputs. In some embodiments, if the second count exceeds 3, the display screen 130 may output at least two first candidate curves when displaying a same chromaticity value under the predetermined reference light, i.e., metamerism happens.

In 1140, the processing engine 112 (e.g., the processor 220, the first spectral curve obtaining module 320) may select the first spectral curve from the plurality of first candidate curves according to a predetermined selecting algorithm. For example, the processing engine 112 may select the first spectral curve that is most similar to the target spectral curve from the plurality of first candidate curves.

In 1150, in response to a determination that the second count does not exceed 3, the processing engine 112 (e.g., the processor 220, the first spectral curve obtaining module 320) may obtain the first spectral curve. In some embodiments, if the second count does not exceed 3, the display screen 130 may output only one first candidate curve when displaying a same chromaticity value under the predetermined reference light, and the processing engine 112 may designate the only one first candidate curve as the first spectral curve.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing operation) may be added elsewhere in the exemplary process 1100. For example, process 1100 may further include storing the trained HMM after obtaining the first spectral curve.

FIG. 12 is a flowchart illustrating an exemplary process 1200 for determining a target spectral curve of a reference object under a predetermined reference light according to some embodiments of the present disclosure. The process 1200 may be executed by the displaying system 100. For example, the process 1200 may be implemented as a set of instructions (e.g., an application) stored in the storage ROM 230 or RAM 240. The processor 220 may execute the set of instructions, and when executing the instructions, it may be configured to perform the process 1200. The operations of the illustrated process presented below are intended to be illustrative. In some embodiments, the process 1200 may be accomplished with one or more additional operations not described and/or without one or more of the operations discussed. Additionally, the order in which the operations of the process as illustrated in FIG. 12 and described below is not intended to be limiting.

In 1210, the processing engine 112 (e.g., the processor 220, the target spectral curve obtaining module 330) may obtain a spectral reflection curve of the reference object.

In some embodiments, the spectral reflection curve of the reference object may reflect inherent reflection features of the reference object. In some embodiments, the spectral reflection curve of the reference object may be stored in a storage device of the displaying system (e.g., the storage 140, the ROM 230, the RAM 240, etc.). The processing engine 112 may access the storage device to obtain the spectral reflection curve of the reference object.

In 1220, the processing engine 112 (e.g., the processor 220, the target spectral curve obtaining module 330) may obtain a spectral curve of the predetermined reference light.

In some embodiments, the spectral curve of the predetermined reference light may reflect a spectral power (or spectral intensity) of the predetermined reference light. In some embodiments, the spectral curve of the predetermined reference light may be stored in a storage device of the displaying system (e.g., the storage 140, the ROM 230, the RAM 240, etc.). The processing engine 112 may access the storage device to obtain the spectral curve of the predetermined reference light.

In 1230, the processing engine 112 (e.g., the processor 220, the target spectral curve obtaining module 330) may determine the target spectral curve based on the spectral reflection curve of the reference object and the spectral curve of the predetermined reference light.

In some embodiments, the processing engine 112 may determine the target spectral curve based on the spectral reflection curve of the reference object and the spectral curve of the predetermined reference light according to a predetermined algorithm. For example, the processing engine 112 may multiply the spectral reflection curve of the reference object by the spectral curve of the predetermined reference light to obtain the target spectral curve.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more other optional operations (e.g., a storing operation) may be added elsewhere in the exemplary process 1200. For example, process 1200 may further include storing the target spectral curve.

FIG. 13 is a flowchart illustrating an exemplary process 1300 for controlling a display screen 130 to display a reference object according to some embodiments of the present disclosure. The process 1300 may be executed by the displaying system 100. For example, the process 1300 may be implemented as a set of instructions (e.g., an application) stored in the storage ROM 230 or RAM 240. The processor 220 may execute the set of instructions, and when executing the instructions, it may be configured to perform the process 1300. The operations of the illustrated process presented below are intended to be illustrative. In some embodiments, the process 1300 may be accomplished with one or more additional operations not described and/or without one or more of the operations discussed. Additionally, the order in which the operations of the process as illustrated in FIG. 13 and described below is not intended to be limiting.

In 1310, the processing engine 112 (e.g., the processor 220, the controlling module 340) may determine a similarity degree between the first spectral curve and the target spectral curve.

In some embodiments, the similarity degree may reflect a likelihood that the display screen 130 displays the reference object like the reference object naturally displayed in nature scenes. The higher the similarity degree, the more likely that the display screen 130 displays the reference object like the reference object naturally displayed in nature scenes. In some embodiments, the processing engine 112 may determine the similarity degree based on a similarity algorithm.

In 1320, the processing engine 112 (e.g., the processor 220, the controlling module 340) may determine whether the similarity degree is less than a similarity threshold.

In some embodiments, the similarity threshold may be used to determine whether the display screen 130 displays the reference object close to the reference object naturally displayed in nature scenes. In some embodiments, the similarity threshold may be a predetermined value and stored in a storage device of the displaying system (e.g., the storage 140, the ROM 230, the RAM 240, etc.).

In 1330, in response to a determination that the similarity degree is less than the similarity threshold, the processing engine 112 (e.g., the processor 220, the controlling module 340) may adjust one or more parameters associated with the backlight source of the display screen.

In some embodiments, in response to the determination that the similarity degree is less than the similarity threshold, the processing engine determine that the display effect on the display screen 130 is not close to the natural display effect of the reference object, and may further adjust parameters associated with the backlight source. In some embodiments, the processing engine 112 may turn on one or more off-working channels to increase the current count of working channels of the backlight source. For example, in a backlight source having five channels, the current count of working channels is 3. The processing engine 112 may turn on one off-working channel of the backlight source. In some embodiments, the processing engine 112 may turn off one or more working channels to decrease to the current count of working channels of the backlight source. For example, in a backlight source having four channels of R channel, G channel, B channel, and W channel, the current count of working channels is 4. The processing engine 112 may turn off one working channel (such as B channel) of the backlight source. In some embodiments, the processing engine 112 may add a filter to the backlight source to adjust parameters of backlight source to make the display effect on the display screen 130 close to the natural display effect.

In 1340, in response to a determination that the similarity degree is not less than the similarity threshold, the processing engine 112 (e.g., the processor 220, the controlling module 340) may control the display screen to display the reference object based on the first spectral curve.

In some embodiments, if the similarity is greater than a similarity threshold, the processing engine 112 may determine that the display effect that the display screen 130 displays the reference object close to the natural display effect of the reference object. The processing engine 112 may instruct the display screen 130 to display the reference object directly after adjusting the one or more parameters of the backlight source.

FIG. 14 is a flowchart illustrating an exemplary process 1400 for assessing a display screen 130 according to some embodiments of the present disclosure. The process 1400 may be executed by the displaying system 100. For example, the process 1400 may be implemented as a set of instructions (e.g., an application) stored in the storage ROM 230 or RAM 240. The processor 220 may execute the set of instructions, and when executing the instructions, it may be configured to perform the process 1400. The operations of the illustrated process presented below are intended to be illustrative. In some embodiments, the process 1400 may be accomplished with one or more additional operations not described and/or without one or more of the operations discussed. Additionally, the order in which the operations of the process as illustrated in FIG. 14 and described below is not intended to be limiting.

In 1410, the processing engine 112 (e.g., the processor 220, the assessing module 350, the chromaticity-performance relation determining module 410) may determine a chromaticity-performance relation.

In some embodiments, the chromaticity-performance relation may reflect a function between a chromaticity value of a pixel and an assessment index of the pixel. In some embodiments, the chromaticity value of a pixel and an assessment index thereof may have a one-to-one manner. For example, knowing a chromaticity value of the pixel, the corresponding assessment index of the pixel may be determined according to the chromaticity-performance relation. In some embodiments, the chromaticity value may refer to a parameter associated with a chromaticity of the pixel. For example, the chromaticity values may include a CIE 1931 xy chromaticity value of the pixel, a gray intensity of the pixel, or the like, or any combination thereof. In some embodiments, chromaticity-performance relation may be in a form of a contour map, a fitting function, a fitted curve, an explicit function, or the like, or any combination thereof.

In some embodiments, the assessment index may include a luminous efficiency of radiation (LER), a melanotic efficiency of radiation (M_{Z}ER), a melanotic/photopic ratio (M_{Z}/P), a blue light hazard (BLH), an illumination or brightness, an equivalent melatonin illumination or brightness, a circadian light (CL_{A}), or the like, or any combination thereof. In some embodiments, the LER of the display screen 130 may reflect an energy consumption and intensity of visible light emitted from the display screen 130. In some embodiments, the M_{Z}ER of the display screen 130 may reflect biological impact (e.g., melatonin) of the display screen 130 on human beings. In some embodiments, the BLH of the display screen 130 may reflect impacts on human beings caused by blue light emitted from the display screen 130.

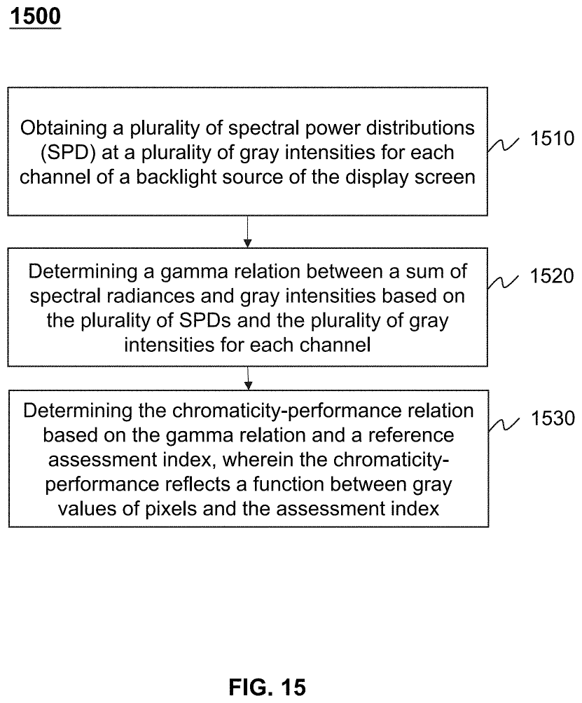

In some embodiments, the processing engine 112 may determine a chromaticity-performance relation reflecting a function between gray intensities of pixels and an assessment index. In some embodiments, the processing engine 112 may determine a chromaticity-performance relation reflecting a function between CIE xy values of pixels and an assessment index. In some embodiments, an exemplary process for determining the chromaticity-performance relation may be found elsewhere (e.g., FIG. 15, FIG. 18 and the descriptions thereof) in the present disclosure. In some embodiments, the chromaticity-performance relation may be predetermined and stored in a storage device of the displaying system (e.g., the storage 140, the ROM 230, the RAM 240, etc.). The processing engine 112 may access the storage device to obtain the chromaticity-performance relation.

In 1420, for each pixel in a plurality of frames displayed on the display screen, the processing engine 112 (e.g., the processor 220, the assessing module 350, the chromaticity value determining module 420) may determine a chromaticity value of the pixel.

In some embodiments, the processing engine 112 may determine a CIE xy value of each pixel. For example, the processing engine 112 may determine a spectrum proportion of each channel of the backlight source contributes when the display screen 130 display a pixel, and determine the CIE xy value of the pixel according to an algorithm, a function, a model, or the like, or any combination thereof. In some embodiments, the CIE xy value of each pixel may be determined according to known processes but not be limited here. In some embodiments, the processing engine 112 may determine a gray intensity of each channel of the backlight source.

In 1430, the processing engine 112 (e.g., the processor 220, the assessing module 350, the assessment index determining module 430) may determine an assessment index of the display screen 130 based on the chromaticity values of the pixels in the plurality of frames and the chromaticity-performance relation.

In some embodiments, the display screen 130 may influence the health of human beings over long durations of usage of the display screen 130. The processing engine 112 may determine the assessment index of the display screen 130 based on frames that displayed thereof over long durations.

In some embodiments, the processing engine 112 may input the CIE xy value of a pixel into the chromaticity-performance relation reflecting a function between CIE xy values of pixels and an assessment index. The processing engine 112 may determine the assessment index of the pixel. In some embodiments, the processing engine 112 may input the gray intensity of a pixel into the chromaticity-performance relation reflecting a function between gray intensities of pixels and an assessment index. The processing engine 112 may determine the assessment index of the pixel.

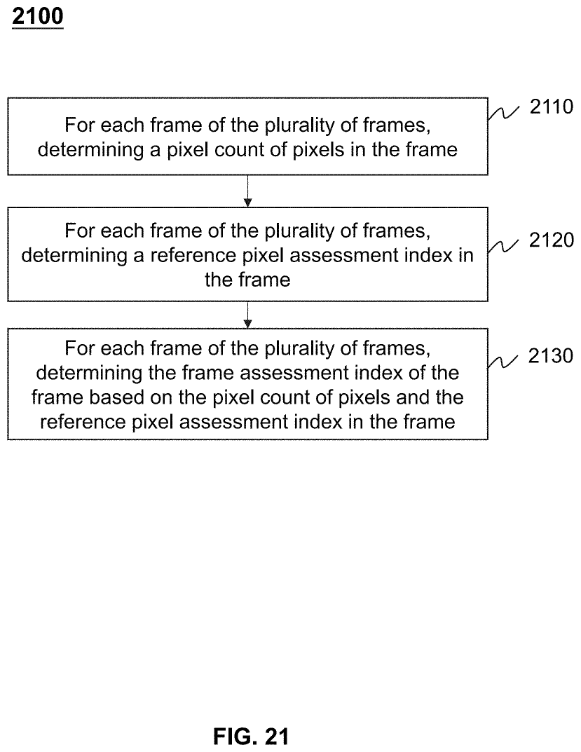

In some embodiments, the processing engine 112 may determine the assessment index of the display screen 130 based on frame assessment indexes of frames displayed on the display screen 130. In some embodiments, the processing engine 112 may determine a frame assessment index of a frame based on assessment indexes of pixels in the frame. For example, the processing engine 112 may add an assessment index of each pixel in the frame to obtain the frame assessment index of the frame. As another example, the processing engine 112 may determine a reference pixel in the frame, and determine a pixel count of pixels in the frame. The processing engine 112 may multiply a reference pixel assessment index of the reference pixel by the pixel count of pixels in the frame to obtain the frame assessment index of the frame. An exemplary process for determining a frame assessment index of a frame may be found elsewhere (e.g., FIG. 21 and the descriptions thereof) in the present disclosure.

FIG. 15 is a flowchart illustrating an exemplary process 1500 for determining a chromaticity-performance relation according to some embodiments of the present disclosure. The process 1500 may be executed by the displaying system 100. For example, the process 1500 may be implemented as a set of instructions (e.g., an application) stored in the storage ROM 230 or RAM 240. The processor 220 may execute the set of instructions, and when executing the instructions, it may be configured to perform the process 1500. The operations of the illustrated process presented below are intended to be illustrative. In some embodiments, the process 1500 may be accomplished with one or more additional operations not described and/or without one or more of the operations discussed. Additionally, the order in which the operations of the process as illustrated in FIG. 15 and described below is not intended to be limiting.

In 1510, the processing engine 112 (e.g., the processor 220, the assessing module 350, the chromaticity-performance relation determining module 410) may obtain a plurality of spectral power distributions (SPD) at a plurality of gray intensities for each channel of a backlight source of the display screen 130.

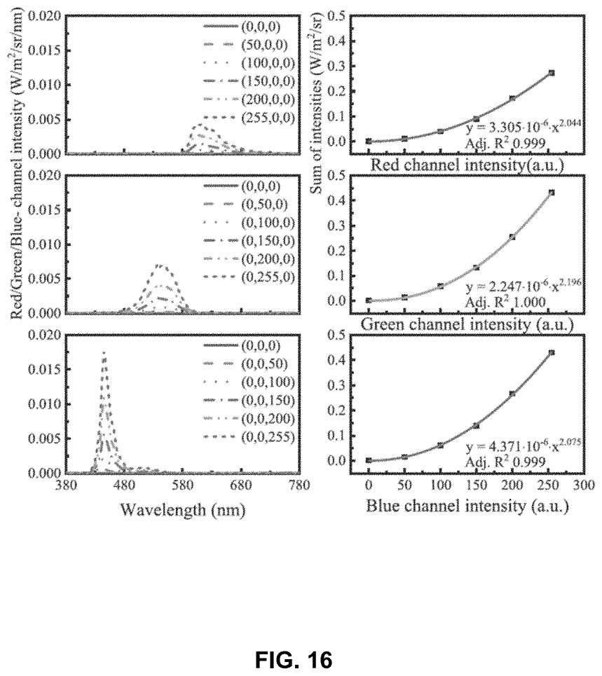

For example, the backlight source may include three channels of R channel, G channel, and B channel. FIG. 16 are schematic diagrams illustrating exemplary spectral radiances of red, green, and blue channels (left column) and a sum of spectral radiances as functions of gray intensity (right column) according to some embodiments of the present disclosure. As shown in the left column of FIG. 16, the processing engine 112 obtain a SPD of each of (0,0,0), (50,0,0), (100,0,0), (150,0,0), (200,0,0), and (255,0,0) for R channel, each of (0,0,0), (0,50,0), (0,100,0), (0,150,0), (0,200,0), and (0,255,0) for G channel, and each of (0,0,0), (0,0,50), (0,0,100), (0,0,150), (0,0,200), and (0,0,255) for B channel, respectively.

In 1520, the processing engine 112 (e.g., the processor 220, the assessing module 350, the chromaticity-performance relation determining module 410) may determine a gamma relation between a sum of spectral radiances and gray intensities based on the plurality of SPDs and the plurality of gray intensities for each channel.

In some embodiments, the processing engine 112 may establish a relation between a sum of spectral radiances and gray intensities for each channel according to a fitting function. For example, the fitting function may include a power function, an exponential function, a quadratic equation in one unknown, a cubic equation in one unknown, or the like, or any combination thereof. For example, as shown in the right column of FIG. 16, the processing engine 112 may establish the gamma relation Y=aX^{Y} between a sum of spectral radiances and gray intensities for R channel, G channel, and B channel, respectively. Y denotes a sum of intensity, x denotes a gray intensity, a denotes a coefficient, and y denotes a gamma correction coefficient.

In 1530, the processing engine 112 (e.g., the processor 220, the assessing module 350, the chromaticity-performance relation determining module 410) may determine the chromaticity-performance relation based on the gamma relation and a reference assessment index. In some embodiments, the chromaticity-performance may reflect a function between gray values of pixels and the assessment index.

In some embodiments, the reference assessment index may be a maximum assessment index of each channel. For example, the reference assessment index may be a maximum assessment index that the display screen 130 generate when only one channel is turned on (i.e., only one working channel). The processing engine 112 may determine a spectrum proportion of each channel based on the gamma relation. The processing engine 112 may determine the chromaticity-performance relation based on the spectrum proportion of each channel and the maximum assessment index of each channel.

In some embodiments, the reference assessment index may be a maximum LER of each channel. For example, the maximum LER may be expressed in lumens per watt, and may be determined according to Equation (1):

LER=Kₘ∫₃₈₀⁷⁸⁰P(λ)V(λ)dλ/∫₃₈₀⁷⁸⁰P(λ)dλ, (1),

wherein Kₘ=683 lm/W is a maximum photopic luminous efficacy, P(λ) denotes a SPD of a light source or a spectral intensity of each pixel, V(λ) denotes a predetermined spectral sensitivity curve of a human eye under photopic vision. The sensitivity curve may be the mean response of human beings to monochromatic light as a function of wavelength. λ represents wavelength, and the limits of the integrations are from 380 nm to 780 nm, which are the visible light range. In some embodiments, if P(λ) denotes a SPD of a light source, the LER determined by Equation (1) may be a relative value. If P(λ) denotes a spectral intensity of the light source, the LER determined by Equation (1) may be an absolute value. In some embodiments, V(λ)=1/E_{λ}, wherein E_{λ} denotes energy of monochromatic light. In some embodiments, under different illumination, V(λ) may be varied. In some embodiments, under illumination with a luminance greater than 3 cd/m², pyramidal cells play an important role in photopic vision, and a peak value of V(λ) is 555 nm; under illumination with a luminance less than 0.03 cd/m², somatic cells play an important role in scotopic vision, and the peak value of V(λ) moves towards a direction of short wavelength, which is 507 nm; under illumination with a luminance between 0.03 cd/m² and 3 cd/m², the pyramidal cells and the somatic cells work together in mesopic vision.

In some embodiments, the reference assessment index may be a maximum M_{Z}ER of each channel. For example, the maximum M_{Z}ER may be expressed in bio-lumens per watt, and determined according to Equation (2):

M_{Z}ER=K∫₃₈₀⁷⁸⁰P(λ)M(λ)dλ/∫₃₈₀⁷⁸⁰P(λ)dλ (2),

wherein K=832 blm/W is the maximum melanotic luminous efficiency, M(λ) denotes a predetermined melanotic sensitivity curve.

In some embodiments, melatonin is one of the hormones secreted by a pineal gland in the human brain. It may shorten the time of awakening and falling asleep before going to bed, improve sleep quality, and whiten skin. Modern medicine has shown that human melatonin may be affected by light, and the light emitted by the display screen 130 may affect the secretion of human melatonin. Therefore, melatonin is included in the health performance evaluation of the display screen 130 to effectively protect the normal secretion of human melatonin.

In some embodiments, the reference assessment index may be a maximum M_{Z}/P of each channel. For example, the maximum M_{Z}/P of the display screen 130 may reflect the biological impact per luminous flux of the display screen 130. In some embodiments, the M_{Z}/P may be determined according to Equation (3):

M_{z}/P=M_{z}ER/LER=K∫₃₈₀⁷⁸⁰P(λ)M_{z}(λ)dλ/Kₘ∫₃₈₀⁷⁸⁰P(λ)V(λ)dλ (3).

In some embodiments, the reference assessment index may be a maximum BLH of each channel. For example, the maximum BLH may be determined according to Equation (4):

BLH=K_{B}∫₃₈₀⁷⁸⁰P(λ)B(λ)dλ/∫₃₈₀⁷⁸⁰P(λ)dλ (4),

wherein K_{B} is a predetermined coefficient, B(λ) denotes a predetermined harm response curve of blue light.

In some embodiments, the processing engine 112 may store the chromaticity-performance relation of a display screen in a storage device of the displaying system (e.g., the storage 140, the ROM 230, the RAM 240, etc.) together with the corresponding model or model number of the display screen. The processing engine 112 may determine an assessment index of a same model or same model number of display screen based on the chromaticity-performance relation stored in the storage device.

It should be noted that LER, M_{Z}ER, BLH are only for illustration purpose, other assessment indexes, such as an illumination or brightness, an equivalent melatonin illumination or brightness, a circadian light (CL_{A}), etc, may be determined in similarly way to be used to assess the display screen 130.

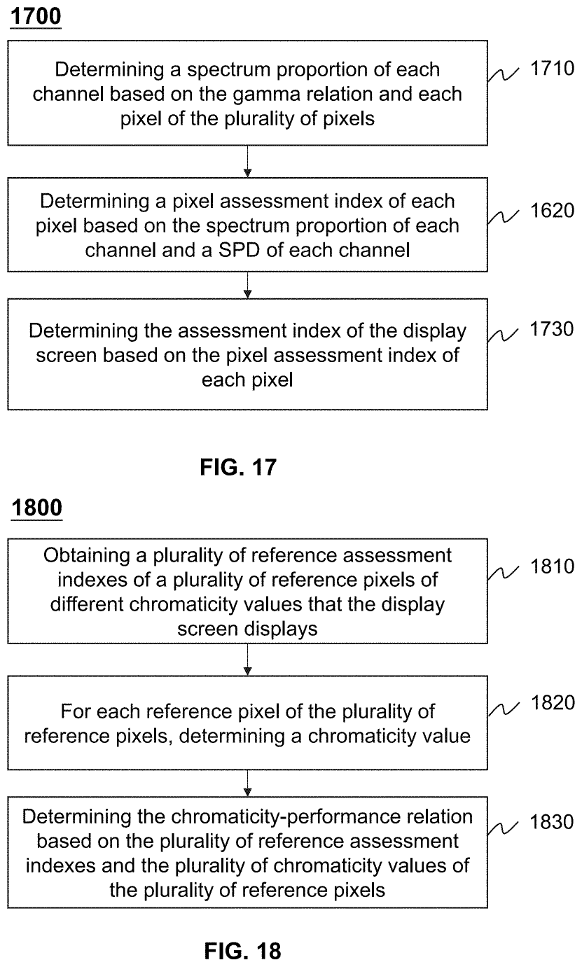

FIG. 17 is a flowchart illustrating an exemplary process 1700 for determining an assessment index of a display screen according to some embodiments of the present disclosure. The process 1700 may be executed by the displaying system 100. For example, the process 1700 may be implemented as a set of instructions (e.g., an application) stored in the storage ROM 230 or RAM 240. The processor 220 may execute the set of instructions, and when executing the instructions, it may be configured to perform the process 1700. The operations of the illustrated process presented below are intended to be illustrative. In some embodiments, the process 1700 may be accomplished with one or more additional operations not described and/or without one or more of the operations discussed. Additionally, the order in which the operations of the process as illustrated in FIG. 17 and described below is not intended to be limiting.

In 1710, the processing engine 112 (e.g., the processor 220, the assessing module 350, the assessment index determining module 430) may determine a spectrum proportion of each channel based on the gamma relation and each pixel of the plurality of pixels.

For example, for a given gray value of a pixel, the processing engine 112 may obtain the spectrum proportion of R channel, G channel, and B channel, respectively, using the gamma relation. For example, R channel may contribute 50% spectrum proportion, G channel may contribute 30% spectrum proportion, and B channel may contribute 20% spectrum proportion.

In 1720, the processing engine 112 (e.g., the processor 220, the assessing module 350, the assessment index determining module 430) may determine a pixel assessment index of each pixel based on the spectrum proportion of each channel and a SPD of each channel.

For example, the processing engine 112 may determine a maximum assessment index of each channel based on the SPD of each channel according to any one of Equations (1)-(4). The processing engine 112 may determine the pixel assessment index by multiplying the spectrum proportion of each channel and the corresponding maximum assessment index. For example, the pixel assessment index of the pixel may be equal to 50%×a maximum assessment index of R channel+30%×a maximum assessment index of G channel+20%×a maximum assessment index of B channel.

In 1730, the processing engine 112 (e.g., the processor 220, the assessing module 350, the assessment index determining module 430) may determine the assessment index of the display screen based on the pixel assessment index of each pixel. Exemplary processes for determining the assessment index of the display screen may be found elsewhere (e.g., FIGS. 20-22 and the descriptions thereof) in the present disclosure.

FIG. 18 is a flowchart illustrating an exemplary process 1800 for determining a chromaticity-performance relation according to some embodiments of the present disclosure. The process 1800 may be executed by the displaying system 100. For example, the process 1800 may be implemented as a set of instructions (e.g., an application) stored in the storage ROM 230 or RAM 240. The processor 220 may execute the set of instructions, and when executing the instructions, it may be configured to perform the process 1800. The operations of the illustrated process presented below are intended to be illustrative. In some embodiments, the process 1800 may be accomplished with one or more additional operations not described and/or without one or more of the operations discussed. Additionally, the order in which the operations of the process as illustrated in FIG. 18 and described below is not intended to be limiting.

In 1810, the processing engine 112 (e.g., the processor 220, the assessing module 350, the chromaticity-performance relation determining module 410) may obtain a plurality of reference assessment indexes of a plurality of reference pixels of different chromaticity values that the display screen 130 displays.

In some embodiments, the plurality of reference pixels may be displayed on the display screen 130. For example, the plurality of reference pixels may include all pixels in frames that displayed on the display screen 130. As another example, the plurality of reference pixels may include part of all the pixels in frames that displayed on the display screen 130. As still another example, the plurality of reference pixels may be selected from all the pixels that are relatively uniformly distributed in the CIE 1931 chromaticity diagram. In some embodiments, for each reference pixel of the plurality of reference pixels, the processing engine 112 may obtain spectral information of the reference pixel and determine the reference assessment index of the reference pixel based on the spectral information of the reference pixel. For example, the processing engine 112 may input the spectral information of the reference pixel into any one of Equations (1)-(4) to obtain the reference assessment index of the reference pixel. In some embodiments, the spectral information may include SPD information or spectral intensity information of the reference pixel.

In 1820, for each reference pixel of the plurality of reference pixels, the processing engine 112 (e.g., the processor 220, the assessing module 350, the chromaticity-performance relation determining module 410) may determine a chromaticity value.

In 1830, for each reference pixel of the plurality of reference pixels, the processing engine 112 (e.g., the processor 220, the assessing module 350, the chromaticity-performance relation determining module 410) may determine the chromaticity-performance relation based on the plurality of reference assessment indexes and the plurality of chromaticity values of the plurality of reference pixels.

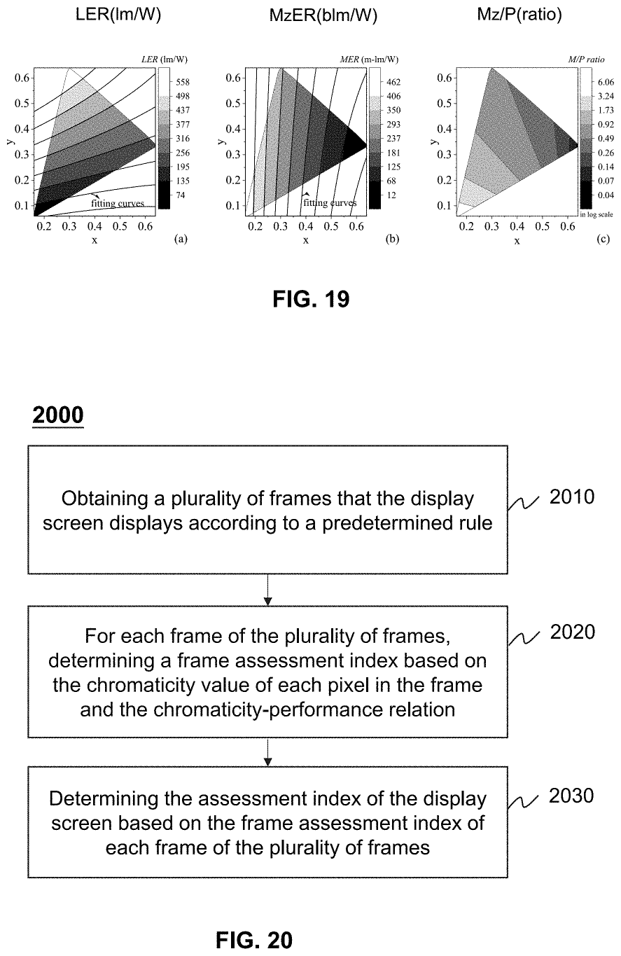

FIG. 19 are schematic diagrams illustrating exemplary chromaticity-performance relations according to some embodiments of the present disclosure. In some embodiments, the processing engine 112 may establish contour maps as functions of the chromaticity value xy as shown in FIG. 19. As shown in FIG. 19, (a) illustrates a CIE chromaticity value-LER relation, (b) illustrates a CIE chromaticity value-M_{Z}ER relation, and (c) illustrates a CIE chromaticity value-M_{Z}/P relation. In some embodiments, the processing engine 112 may fit the contour maps as functions of CIE chromaticity xy value using a power function, an exponential function, or the like, or any combination thereof. For example, the processing engine 112 may fit the contour maps as functions of CIE chromaticity xy value using Equation (5):

AER(x,y)=a−bx+cy+dx²−ey²−fxy (5),

wherein AER denotes M_{Z}ER or LER, and a, b, c, d, e, f denotes a coefficient, respectively.

FIG. 20 is a flowchart illustrating an exemplary process 2000 for determining an assessment index of a display screen according to some embodiments of the present disclosure. The process 2000 may be executed by the displaying system 100. For example, the process 2000 may be implemented as a set of instructions (e.g., an application) stored in the storage ROM 230 or RAM 240. The processor 220 may execute the set of instructions, and when executing the instructions, it may be configured to perform the process 2000. The operations of the illustrated process presented below are intended to be illustrative. In some embodiments, the process 2000 may be accomplished with one or more additional operations not described and/or without one or more of the operations discussed. Additionally, the order in which the operations of the process as illustrated in FIG. 20 and described below is not intended to be limiting.

In 2010, the processing engine 112 (e.g., the processor 220, the assessing module 350, the assessment index determining module 430) may obtain a plurality of frames that the display screen 130 displays according to a predetermined rule.

In some embodiments, the predetermined rule may be predetermined by the displaying system 100 or an operator thereof, and stored in a storage device of the displaying system (e.g., the storage 140, the ROM 230, the RAM 240, etc.). In some embodiments, the processing engine 112 may obtain a frame that the display screen 130 displays every a predetermined time interval (e.g., 5 seconds, 30 seconds, 2 minutes, etc.) to obtain the plurality of frames. In some embodiments, the processing engine 112 may obtain frames that have a predetermined content to obtain the plurality of frames.

In 2020, for each frame of the plurality of frames, the processing engine 112 (e.g., the processor 220, the assessing module 350, the assessment index determining module 430) may determine a frame assessment index based on the chromaticity value of each pixel in the frame and the chromaticity-performance relation.

In some embodiments, the processing engine 112 may determine a frame assessment index of a frame based on assessment indexes of pixels in the frame. For example, the processing engine 112 may add an assessment index of each pixel in the frame to obtain the frame assessment index of the frame.

In 2030, the processing engine 112 (e.g., the processor 220, the assessing module 350, the assessment index determining module 430) may determine the assessment index of the display screen based on the frame assessment index of each frame of the plurality of frames.

In some embodiments, the processing engine 112 may add a frame assessment index of each frame of the plurality of frames to obtain the assessment index of display screen 130.

FIG. 21 is a flowchart illustrating an exemplary process 2100 for determining a frame assessment index of a frame according to some embodiments of the present disclosure. The process 2100 may be executed by the displaying system 100. For example, the process 2100 may be implemented as a set of instructions (e.g., an application) stored in the storage ROM 230 or RAM 240. The processor 220 may execute the set of instructions, and when executing the instructions, it may be configured to perform the process 2100. The operations of the illustrated process presented below are intended to be illustrative. In some embodiments, the process 2100 may be accomplished with one or more additional operations not described and/or without one or more of the operations discussed. Additionally, the order in which the operations of the process as illustrated in FIG. 21 and described below is not intended to be limiting.

In 2110, for each frame of the plurality of frames, the processing engine 112 (e.g., the processor 220, the assessing module 350, the assessment index determining module 430) may determine a pixel count of pixels in the frame. In some embodiments, the pixel count may be a total count of pixels in the frame.

In 2120, for each frame of the plurality of frames, the processing engine 112 (e.g., the processor 220, the assessing module 350, the assessment index determining module 430) may determine a reference pixel assessment index in the frame. In some embodiments, the reference pixel assessment index may be a pixel assessment index of a pixel that is randomly selected from the pixels in the frame. In some embodiments, the reference pixel assessment index may be a pixel assessment index of a pixel that has an average chromaticity value of the pixels in the frame.

In 2130, for each frame of the plurality of frames, the processing engine 112 (e.g., the processor 220, the assessing module 350, the assessment index determining module 430) may determine the frame assessment index of the frame based on the pixel count of pixels and the reference pixel assessment index in the frame. In some embodiments, the processing engine 112 may multiply the reference pixel assessment index by the pixel count of pixels in the frame to obtain the frame assessment index of the frame.

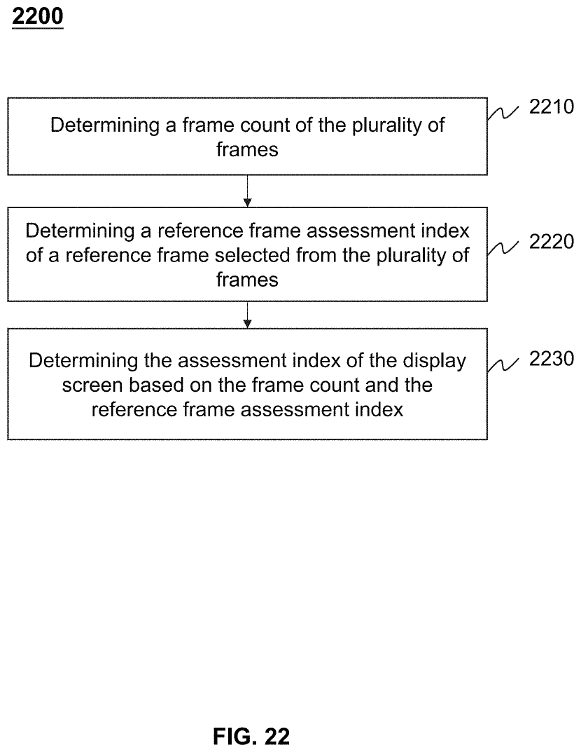

FIG. 22 is a flowchart illustrating an exemplary process 2200 for determining an assessment index of a display screen according to some embodiments of the present disclosure. The process 2200 may be executed by the displaying system 100. For example, the process 2200 may be implemented as a set of instructions (e.g., an application) stored in the storage ROM 230 or RAM 240. The processor 220 may execute the set of instructions, and when executing the instructions, it may be configured to perform the process 2200. The operations of the illustrated process presented below are intended to be illustrative. In some embodiments, the process 2200 may be accomplished with one or more additional operations not described and/or without one or more of the operations discussed. Additionally, the order in which the operations of the process as illustrated in FIG. 22 and described below is not intended to be limiting.

In 2210, the processing engine 112 (e.g., the processor 220, the assessing module 350, the assessment index determining module 430) may determine a frame count of the plurality of frames displayed on the display screen 130. In some embodiments, the frame count may be a total count of frames displayed on the display screen 130. In some embodiments, the frame count may be a total count of the plurality of frames displayed on the display screen 130 during a predetermined time period.

In 2220, the processing engine 112 (e.g., the processor 220, the assessing module 350, the assessment index determining module 430) may determine a reference frame assessment index of a reference frame selected from the plurality of frames. In some embodiments, the reference frame assessment index may be a frame assessment index of a reference frame that is randomly selected from the plurality of frames.

In 2230, the processing engine 112 (e.g., the processor 220, the assessing module 350, the assessment index determining module 430) may determine the assessment index of the display screen 130 based on the frame count of frames and the reference frame assessment index. In some embodiments, the processing engine 112 may multiply the reference frame assessment index by the frame count to obtain the assessment index of the display screen 130.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the descriptions, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

1. A displaying system, comprising:
at least one storage medium including a set of instructions; and
at least one processor in communication with the storage medium, wherein when executing the set of instructions, the at least one processor is directed to cause the system to perform operations including:
adjusting one or more parameters of a backlight source of a display screen, wherein the one or more parameters include: a spectral full width at half maximum (FWHM) of a working channel of the backlight source, a peak wavelength of a working channel of the backlight source, and a first count of working channels of the backlight source;
obtaining a first spectral curve of a reference object that the display screen displays under a predetermined reference light after adjusting the one or more parameters of the backlight source of the display screen;
obtaining a target spectral curve of the reference object under the predetermined reference light; and
controlling the display screen to display the reference object based on the first spectral curve and the target spectral curve.

2. The displaying system of claim 1, wherein the adjusting the one or more parameters includes at least one of:
increasing a spectral FWHM of a first working channel of the backlight source to a first value greater than a first width threshold;
decreasing a spectral FWHM of a second working channel of the backlight source to a second value less than a second width threshold; or
increasing the first count of working channels of the backlight source.

3. The displaying system of claim 1, wherein the operations further include:
determining the continuity degree of the first spectral curve according to a spectral similarity algorithm, wherein a continuity degree of the first spectral curve exceeds a predetermined continuity threshold.

4. The displaying system of claim 1, wherein the obtaining the first spectral curve includes:
determining a second count of total channels of the backlight source;
determining whether the second count exceeds 3;
in response to a determination that the second count exceeds 3, obtaining a plurality of first candidate curves under the predetermined reference light that the display screen outputs; and
selecting the first spectral curve from the plurality of first candidate curves according to a predetermined selecting algorithm.

5. The displaying system of claim 1, wherein the obtaining the target spectral curve includes:
obtaining a spectral reflection curve of the reference object;
obtaining a spectral curve of the predetermined reference light; and
determining the target spectral curve based on the spectral reflection curve of the reference object and the spectral curve of the predetermined reference light.

6. The displaying system of claim 1, wherein the controlling the display screen to display the reference object includes:
determining a similarity degree between the first spectral curve and the target spectral curve;
determining whether the similarity degree is less than a similarity threshold;
in response to a determination that the similarity degree is less than the similarity threshold, adjusting one or more parameters associated with the backlight source of the display screen.

7. The displaying system of claim 6, wherein the operations further include:
in response to a determination that the similarity degree is not less than the similarity threshold, controlling the display screen to display the reference object based on the first spectral curve.

8. The displaying system of claim 1, wherein the operations further include:
determining an assessment index of the display screen, wherein the assessment index includes at least one of: a luminous efficiency of radiation (LER), a melanotic efficiency of radiation (M_{Z}ER), a melanotic/photopic ratio (M_{Z}/P), or a blue light hazard (BLH).

9. The displaying system of claim 8, wherein the determining the assessment index includes:
determining a chromaticity-performance relation, wherein the chromaticity-performance relation reflects a function between a chromaticity value of a pixel and an assessment index of the pixel;
for a pixel in a plurality of frames displayed on the display screen, determining a chromaticity value of the pixel; and
determining the assessment index based on the chromaticity values of the pixels in the plurality of frames and the chromaticity-performance relation.

10. A system for assessing a display screen, comprising:
at least one storage medium including a set of instructions for assessing the display screen; and
at least one processor in communication with the storage medium, wherein when executing the set of instructions, the at least one processor is directed to cause the system to perform operations including:
determining a chromaticity-performance relation, wherein the chromaticity-performance relation reflects a function between a chromaticity value of a pixel and an assessment index of the pixel, and the assessment index includes at least one of: a luminous efficiency of radiation (LER), a melanotic efficiency of radiation (M_{Z}ER), a melanotic/photopic ratio (M_{Z}/P), or a blue light hazard (BLH);
for each pixel in a plurality of frames displayed on the display screen, determining a chromaticity value of the pixel; and
determining an assessment index of the display screen based on the chromaticity values of the pixels in the plurality of frames and the chromaticity-performance relation.

11. The system of claim 10, wherein the chromaticity values include CIE 1931 xy chromaticity values or gray intensities.

12-20. (canceled)

21. A displaying method, comprising:
adjusting one or more parameters of a backlight source of a display screen, wherein the one or more parameters include: a spectral full width at half maximum (FWHM) of a working channel of the backlight source, a peak wavelength of a working channel of the backlight source, and a first count of working channels of the backlight source;
obtaining a first spectral curve of a reference object that the display screen displays under a predetermined reference light after adjusting the one or more parameters of the backlight source of the display screen;
obtaining a target spectral curve of the reference object under the predetermined reference light; and
controlling the display screen to display the reference object based on the first spectral curve and the target spectral curve.

22. The displaying method of claim 21, wherein the adjusting the one or more parameters includes at least one of:
increasing a spectral FWHM of a first working channel of the backlight source to a first value greater than a first width threshold;
decreasing a spectral FWHM of a second working channel of the backlight source to a second value less than a second width threshold; or
increasing the first count of working channels of the backlight source.

23. The displaying method of claim 21, further comprising:
determining the continuity degree of the first spectral curve according to a spectral similarity algorithm, wherein a continuity degree of the first spectral curve exceeds a predetermined continuity threshold.

24. The displaying method of claim 21, wherein the obtaining the first spectral curve includes:
determining a second count of total channels of the backlight source;
determining whether the second count exceeds 3;
in response to a determination that the second count exceeds 3, obtaining a plurality of first candidate curves under the predetermined reference light that the display screen outputs; and
selecting the first spectral curve from the plurality of first candidate curves according to a predetermined selecting algorithm.

25. The displaying method of claim 21, wherein the obtaining the target spectral curve includes:
obtaining a spectral reflection curve of the reference object;
obtaining a spectral curve of the predetermined reference light; and
determining the target spectral curve based on the spectral reflection curve of the reference object and the spectral curve of the predetermined reference light.

26. The displaying method of claim 21, wherein the controlling the display screen to display the reference object includes:
determining a similarity degree between the first spectral curve and the target spectral curve;
determining whether the similarity degree is less than a similarity threshold;
in response to a determination that the similarity degree is less than the similarity threshold, adjusting one or more parameters associated with the backlight source of the display screen.

27. The displaying method of claim 26, further comprising:
in response to a determination that the similarity degree is not less than the similarity threshold, controlling the display screen to display the reference object based on the first spectral curve.

28. The displaying method of claim 21, wherein the operations further include:
determining an assessment index of the display screen, wherein the assessment index includes at least one of: a luminous efficiency of radiation (LER), a melanotic efficiency of radiation (M_{Z}ER), a melanotic/photopic ratio (M_{Z}/P), or a blue light hazard (BLH).

29. The displaying method of claim 28, wherein the determining the assessment index includes:
determining a chromaticity-performance relation, wherein the chromaticity-performance relation reflects a function between a chromaticity value of a pixel and an assessment index of the pixel;
for a pixel in a plurality of frames displayed on the display screen, determining a chromaticity value of the pixel; and
determining the assessment index based on the chromaticity values of the pixels in the plurality of frames and the chromaticity-performance relation.

30-42. (canceled)
